(19) United States
(12) Patent Application Publication
(10) Pub. No.: US 2015/0008235 A1
(43) Pub. Date: Jan. 8, 2015

(54) APPARATUS AND METHOD TO LIMIT SLOSH AND ULLAGE IN A LIQUID CONTAINER

(71) Applicant: Esmaeil Khoshsepehr, New York, NY (US)

(72) Inventor: Esmaeil Khoshsepehr, New York, NY (US)

(21) Appl. No.: 13/937,192

(22) Filed: Jul. 8, 2013

(51) Int. Cl. B65D 90/52; B60P 3/24; F17C 5/06

(52) U.S. Cl. CPC B65D 90/52; F17C 5/06; B60P 3/246
USPC 220/723; 141/114; 220/734

(57) ABSTRACT

A plurality of balloons are disposed inside a liquid container to take up space as liquid is removed from the container. The balloons can be connected to a gas injection system to inject gas into the balloons to keep the liquid fill level in the container to a filled level. This results in little or no sloshing of the liquid inside the container. The balloons can be secured in place by one or more positioning boxes disposed along the container's inside periphery. One or more strings can interconnect the balloons to the positioning boxes.

### BACKGROUND OF THE INVENTION

The present invention relates to vehicle stability and safety devices and, more particularly, to an apparatus and method for reducing or eliminating slosh and ullage in liquid containers such as fuel containers in rockets, airplanes, ships, and cars.

Every vehicle that carriers liquid material or depends on liquid or liquefied fuel has a liquid or fuel container that is often partially filled due to consumption or extraction. When such vehicles accelerate or decelerate, the liquid can slosh inside the container, often generating forces either in the forward direction, the reverse direction, and both directions in sequence as the liquid sloshes back and forth, or even forces from side to side. The movement of the liquid can also change the vehicle's center of gravity, which changes the dynamic characteristics of the vehicle.

The sloshing of liquid in a partially filled container can create hazardous conditions, which is the case for vehicles on the move. For example, as a tanker-towing truck brakes, the liquid can gather in the front of the tanker. As the truck stops, this liquid can slosh backward, causing a reverse force on the truck. If the vehicle brakes are not firmly engaged, the truck could be carried backward (or forward) due to liquid sloshing or in case of a moving truck it could lead to a complete loss of control.

Moreover, when flammable liquids are carried and the container is less than full, flammable vapors can collect in this void space unless the space is filled with an inert gas. This flammable vapor is called ullage and in case of vehicles that use highly volatile fuel it could self-ignite and cause an explosion. This is a dangerous situation in addition to the sloshing due to partial fill.

As can be seen, there is a need for a method and apparatus to prevent liquid from sloshing in a partially filled container. Moreover, there is a need to keep the container as fill, even when liquid is removed from the container.

### SUMMARY OF THE INVENTION

In one aspect of the present invention, a liquid container comprises a plurality of bladders disposed inside the container; and a gas injection system operable to inject or retract a gas into the plurality of bladders as liquid is removed from or added to the container, wherein a liquid level in the container is maintained at a filled level as liquid is removed from the container and the plurality of bladders is filled with the gas.

In another aspect of the present invention, a liquid container comprises a plurality of bladders disposed along a length of the container; a gas injection system operable to inject or retract a gas into the plurality of bladders as liquid is removed from or added to the container; a plurality of connectors for positioning the plurality of bladders inside the container; and a plurality of positioning boxes interconnecting the plurality of connectors with an inside periphery of the container; and a bladder positioning system, wherein a liquid level in the container is maintained at a filled level as liquid is removed from or added to the container and the plurality of bladders is filled with the gas and the bladder positioning system controls the positioning boxes to set and change the position of the bladders for the optimal positioning in respect to the overall vehicle stability and center of gravity in real-time.

In a further aspect of the present invention, a method of preventing sloshing of liquid inside a container comprises injecting gas into a plurality of bladders disposed in the container with a gas injection system; and maintaining a liquid level in the container at a filled level as liquid is removed from the container and the plurality of bladders is filled with the gas.

These and other features, aspects and advantages of the present invention will become better understood with reference to the following drawings, description and claims.

### BRIEF DESCRIPTION OF THE DRAWINGS

FIG. 1A is a side view of a tanker truck, illustrating sloshing of liquid in the tanker truck;

FIG. 1B is a side view of a tanker truck, showing a plurality of balloons filled to take up unused space in the tanker to prevent sloshing of liquid therein, according to an exemplary embodiment of the present invention;

FIG. 2 is a cross sectional axial view showing the inside of the tanker truck of FIG. 1B, without the bladder inflated, illustrating sloshing of the liquid inside the tanker;

FIG. 3 is a cross sectional radial view showing the inside of the tanker truck of FIG. 1B, without the bladder inflated, illustrating sloshing of the liquid inside the tanker;

FIG. 4 is a cross sectional axial view showing the inside of the tanker truck of FIG. 1B, with the bladder inflated, illustrating the liquid filling the tanker, preventing sloshing of the liquid; and

FIG. 5 is a cross sectional radial view (as taken along line 3-3 of FIG. 1B) showing the inside of the tanker truck of FIG. 1B, with the bladder inflated, illustrating the liquid filing the tanker, preventing sloshing of the liquid.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a plurality of balloons disposed inside a liquid container to take up space as liquid is removed from the container. The balloons can be connected to a gas injection system to inject gas into the balloons to keep the liquid fill level in the container to a filled level. This results in little or no sloshing of the liquid inside the container. The balloons can be secured in place by one or more positioning boxes disposed along the container's inside periphery. One or more strings or rods can interconnect the balloons to the positioning boxes.

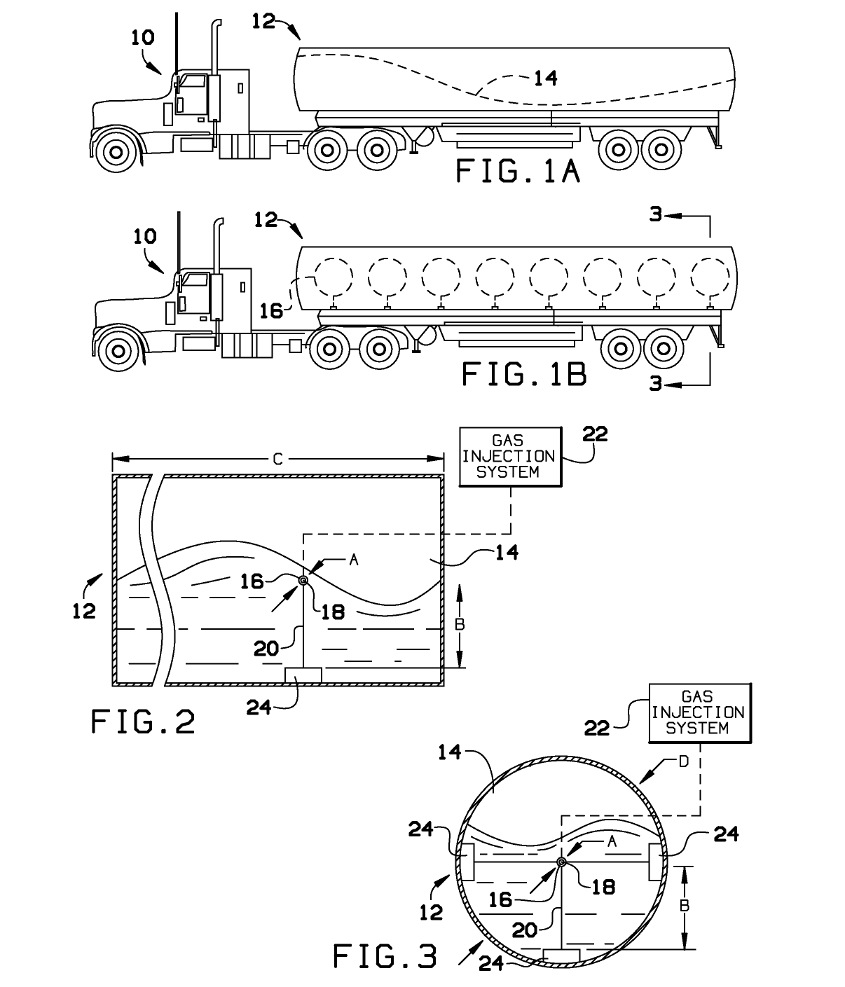

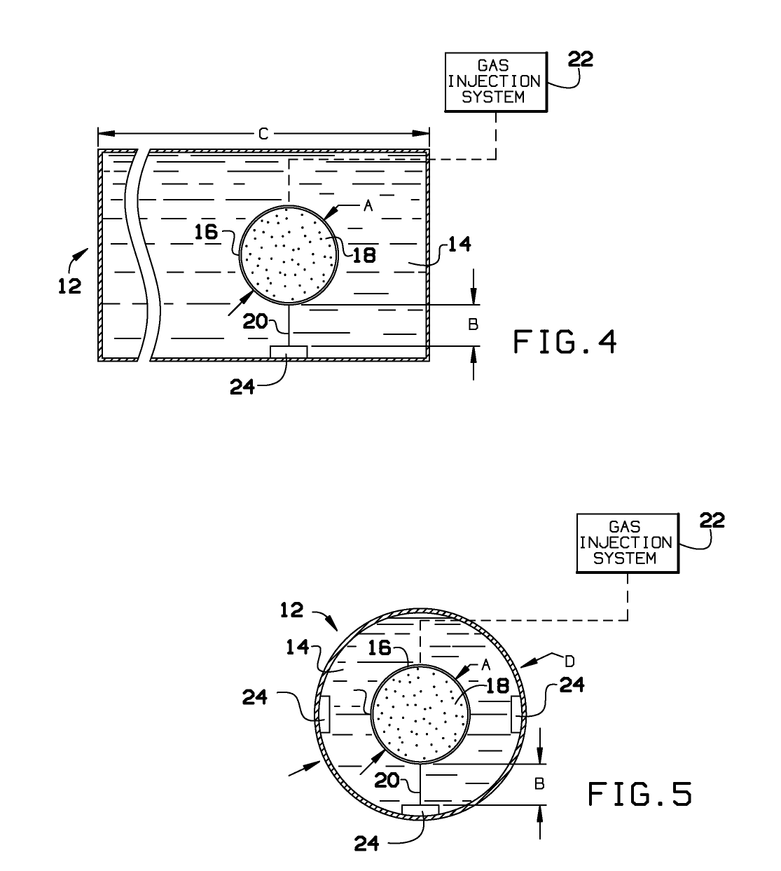

Referring now to FIGS. 1A through 5, a vehicle 10 hauling a liquid tank 12 can be affected by sloshing of the liquid 14 stored therein, especially when the liquid 14 only partially fills the tank 12, as shown in FIG. 1A, for example.

A plurality of bladders 16 can be disposed inside the tank 12 to be filled as liquid 14 is removed from the tank 12, thereby keeping the liquid level inside the tank 12 at a filled level. This can help reduce and even eliminate sloshing of the liquid 14 inside the tank 12. Typically, the bladders 16 are disposed uniformly along the length of the tank 12, as shown in FIG. 1B. Furthermore, typically, the bladders 16 are filled uniformly as liquid 14 is removed. This helps maintain the center of gravity of the tank 12 and evenly disperses the remaining liquid inside the tank 12. However, in some embodiments, the bladders 16 can be disposed in various configurations inside the tank 12 and the bladders 16 may be filled in any particular order.

The tank 12 can have a length C and a radius D. The bladder 16 can have a diameter A. The bladder 16 can be disposed a certain height B above the bottom of the tank 12. The bladder 16 can be held at this height with a rod 20, string or the like. The rod 20 can extend from a positioning box 24 that can be positioned along the length of the tank 12. In some embodiments, as shown in FIG. 3, the positioning box 24 can be disposed on the bottom and opposite sides of the tank 12, and three rods 20 can be used to secure the bladder 16 in an appropriate position. The positioning boxes 24 and the rods 20 can be made from a material that will not react with the contents of the tank 12.

The bladders 16 can be made from a material suitable for use and suitable for contact with the material inside the tank 12. For liquid food products, the bladder 16 can be made from a food grade material. For organic liquids, such as gasoline or fuel oil, the bladders 16 can be made from a chemically inert material.

The bladders 16 can be filled by a gas injection system 22. The bladders 16 can be filled with various materials, such as nitrogen (or some other inert gas 18), air, or even a liquid. The gas injection system 22 can fill the bladders 16 to a certain pressure or can receive a signal from a liquid level detector (not shown) to allow the bladders 16 to fill to keep the liquid level in the tank 12 as a filled or nearly filled level. In some embodiments, the gas injection system 22 can detect the removal of liquid from or addition of the liquid to the container and add or remove gas to the bladders 16 accordingly.

It should be understood, of course, that the foregoing relates to exemplary embodiments of the invention and that modifications may be made without departing from the spirit and scope of the invention as set forth in the following claims.

What is claimed is:

1. A liquid container comprising:
a plurality of bladders disposed in the container; and
a gas injection system operable to inject or retract a gas into or from the plurality of bladders as liquid is removed from or added to the container, wherein
a liquid level in the container is maintained at a filled level as liquid is removed from the container and the plurality of bladders is filled with the gas or as liquid is added to the container and gas is removed from the plurality of bladders.

2. The liquid container of claim 1, further comprising a plurality of connectors for positioning the plurality of bladders in the inside the container.

3. The liquid container of claim 2, further comprising a plurality of positioning boxes interconnecting the plurality of connectors with an inside periphery of the container.

4. The liquid container of claim 1, wherein the gas injection system injects or retracts an inert gas into or from each of the plurality of bladders simultaneously.

5. A liquid container comprising:
a plurality of bladders disposed along a length of the container;
a gas injection system operable to inject or retract a gas into or from the plurality of bladders as liquid is removed from or added to the container;
a plurality of connectors for positioning the plurality of bladders in the inside the container; and
a plurality of positioning boxes interconnecting the plurality of connectors with an inside periphery of the container; and
a bladder positioning system which automatically adjusts and controls the position of the bladders using the positioning box for optimal configuration, wherein
a liquid level in the container is maintained at a filled level as liquid is removed from the container and the plurality of bladders is filled with the gas or as liquid is added to the container and gas is removed from the plurality of bladders.

6. The liquid container of claim 5, wherein the gas injection system injects or retracts an inert gas into or from each of the plurality of bladders simultaneously with the bladder positioning system automatically adjusting and controlling the position of the bladders using the positioning box for optimal configuration.

7. A method of preventing sloshing of liquid inside a container, comprising:
injecting gas into a plurality of bladders disposed in the container with a gas injection system; and
maintaining a liquid level in the container at a filled level as liquid is removed from the container and the plurality of bladders is filled with the gas or as liquid is added to the container and gas is removed from the plurality of bladders.

8. The method of claim 7, further comprising holding the plurality of bladders in the inside of the container with a plurality of connectors.

9. The method of claim 8, further comprising interconnecting the plurality of connectors with an inside periphery of the container with a plurality of positioning boxes.

10. The method of claim 7, wherein the gas injection system injects an inert gas into each of the plurality of bladders simultaneously.
